(19) United States
(12) Patent Application Publication
(10) Pub. No.: US 2025/0156024 A1
(43) Pub. Date: May 15, 2025

(54) APPLICATION DISPLAY METHOD AND ELECTRONIC DEVICE

(71) Applicant: Huawei Technologies Co., Ltd., Shenzhen (CN)

(72) Inventor: Min Wang, Shenzhen (CN)

(21) Appl. No.: 19/024,364

(22) Filed: Jan. 16, 2025

Related U.S. Application Data
(63) Continuation of application No. PCT/CN2023/121609, filed on Sep. 26, 2023.

(30) Foreign Application Priority Data
Sep. 30, 2022 (CN) 202211231820.2

(51) Int. Cl. G06F 3/0481; G06F 3/0484; G06T 13/00

(52) U.S. Cl. CPC G06F 3/0481; G06F 3/0484; G06T 13/00; G06T 2200/24

(57) ABSTRACT

Embodiments of this application provide an application display method and an electronic device. The method includes: The electronic device starts a second activity in response to a first operation of switching a display interface from a first display interface to a second display interface, where a display interface corresponding to the second activity is the second display interface, and an activity corresponding to the first display interface is a first activity; and the electronic device executes a first screen rotation animation for switching from the first display interface to the second display interface.

### CROSS-REFERENCE TO RELATED APPLICATIONS

This application is a continuation of International Patent Application No. PCT/CN2023/121609, filed on Sep. 26, 2023, which claims priority to Chinese Patent Application No. 202211231820.2, filed on Sep. 30, 2022. The disclosures of the aforementioned applications are hereby incorporated by reference in their entireties.

### TECHNICAL FIELD

Embodiments of this application relate to the field of electronic technologies, and more specifically, relate to an application display method and an electronic device.

### BACKGROUND

In a process of using an electronic device, a user often needs to switch a display direction of an application. For example, the user switches a display direction of a display interface of the application from vertical display to horizontal display.

In a process of switching the display direction, a system needs to take a screenshot of a vertical display interface, and display the screenshot on the display interface. In this case, switching can be performed only after a horizontal display interface is drawn. As a result, video playing is temporarily interrupted, causing visual frame freezing.

Therefore, how to avoid frame freezing that occurs when the display direction is switched becomes a technical problem that needs to be resolved.

### SUMMARY

This application provides an application display method and an electronic device. According to the technical solution, when a display direction of an application is switched, different activities may be used to be responsible for display interfaces in different display directions, avoiding frame freezing that occurs when the display direction is switched.

According to a first aspect, an application display method is provided. The method is applied to an electronic device. The method includes: The electronic device starts a second activity in response to a first operation of switching a display interface from a first display interface to a second display interface, where a display interface corresponding to the second activity is the second display interface, an activity corresponding to the first display interface is a first activity, and display directions of the first display interface and the second display interface on a display of the electronic device are different; and the electronic device executes a first screen rotation animation for switching from the first display interface to the second display interface. In this application, after detecting an operation of switching the display direction, the electronic device starts the second activity for the second display interface in another display direction, and then the electronic device executes the first screen rotation animation for switching from the first display interface to the second display interface. According to the technical solution, different activities are used to be responsible for display interfaces in different display directions, and screenshot processing does not need to be performed on an original display interface, avoiding frame freezing that occurs when the display direction is switched.

For example, the first display interface may be a vertical display interface, and the second display interface may be a horizontal display interface.

With reference to the first aspect, in an implementation of the first aspect, the first display interface is a display interface of a video played by the electronic device. Before the electronic device executes the first screen rotation animation for switching from the first display interface to the second display interface, the method further includes: The electronic device switches a video stream of the video from the first activity to the second activity. In this application, when the electronic device plays the video, and when the display direction is switched, the electronic device switches the video stream from the first activity to the second activity, so as to ensure uninterrupted video playing.

In some other examples, the first display interface may be another display interface other than a video playing interface, for example, a text display interface. This is not limited in this application.

With reference to the first aspect, in an implementation of the first aspect, the method further includes: The electronic device draws a third display interface, where the third display interface is a display interface of a status bar of the electronic device. In this application, the electronic device may perform a switching action after drawing the second display interface, without waiting for the status bar to be drawn. The status bar may be drawn after the display direction is switched, so that switching between display interfaces is smoother when the display direction is switched, avoiding frame freezing.

With reference to the first aspect, in an implementation of the first aspect, that the electronic device executes a first screen rotation animation for switching from the first display interface to the second display interface includes: The electronic device obtains animation duration, a start angle, and an end angle of the first screen rotation animation; and the electronic device executes the first screen rotation animation based on the animation duration, the start angle, and the end angle of the first screen rotation animation. In this application, a framework layer of the electronic device may provide a system interface, and the electronic device may obtain an animation through the system interface and execute the animation based on an animation parameter. In this technical solution, when different applications in the electronic device switch display directions, animations may be obtained through the system interface. This helps improve applicability of the animation for switching the display direction.

With reference to the first aspect, in an implementation of the first aspect, the first operation includes at least one of the following operations: an operation of tapping a display direction switching icon on the first display interface; or an operation of rotating the electronic device by a first preset angle.

With reference to the first aspect, in an implementation of the first aspect, the first activity is switched to a background when the display interface of the electronic device is switched from the first display interface to the second display interface. In this application, when the electronic device is switched from the first display interface to the second display interface, the first activity corresponding to the first display interface is switched to the background. In this case, the second activity corresponding to the second display interface is in a foreground. In this technical solution, when the electronic device switches from the second display interface back to the first display interface, the first activity only needs to be switched to the foreground, and the first display interface does not need to be re-drawn, so that switching smoothness can be improved.

With reference to the first aspect, in an implementation of the first aspect, the method further includes: The electronic device detects a second operation of a user, where the second operation is used to switch the display interface of the electronic device from the second display interface to the first display interface; the electronic device switches the second activity from the background to the foreground in response to the second operation; and the electronic device executes a second screen rotation animation for switching from the second display interface to the first display interface. In this application, after detecting the operation of switching from the second display interface back to the first display interface, the electronic device may switch the first activity back to the foreground, and execute the screen rotation animation. In this technical solution, the first display interface does not need to be re-drawn, so that switching smoothness can be improved.

With reference to the first aspect, in an implementation of the first aspect, the second display interface is a display interface of the video played by the electronic device. Before the electronic device executes the second screen rotation animation for switching from the second display interface to the first display interface, the method further includes: The electronic device switches the video stream of the video from the second activity to the first activity. In this application, when the electronic device plays the video, and when the display direction is switched, the electronic device switches the video stream from the second activity to the first activity, so as to ensure uninterrupted video playing.

With reference to the first aspect, in an implementation of the first aspect, that the electronic device executes a second screen rotation animation for switching from the second display interface to the first display interface includes: The electronic device obtains animation duration, a start angle, and an end angle of the second screen rotation animation; and the electronic device executes the second screen rotation animation based on the animation duration, the start angle, and the end angle of the second screen rotation animation. In this application, a framework layer of the electronic device may provide a system interface, and the electronic device may obtain a screen rotation animation through the system interface and execute the screen rotation animation based on an animation parameter. In this technical solution, when different applications in the electronic device switch display directions, screen rotation animations may be obtained through the system interface. This helps improve applicability of the screen rotation animation for switching the display direction.

With reference to the first aspect, in an implementation of the first aspect, the second operation includes at least one of the following operations: an operation of tapping a display direction switching icon on the second display interface; or an operation of rotating the electronic device by a second preset angle.

According to a second aspect, an electronic device is provided, including one or more processors and one or more memories. The one or more memories store one or more computer programs. The one or more computer programs include instructions. When the instructions are executed by the one or more processors, the application display method according to any one of the first aspect or the possible implementations of the first aspect is performed.

According to a third aspect, an electronic device is provided, including a module configured to implement the application display method according to any one of the first aspect or the possible implementations of the first aspect.

According to a fourth aspect, a chip is provided. The chip includes a processor and a communication interface. The communication interface is configured to: receive a signal and transmit the signal to the processor. The processor processes the signal, so that the application display method according to any one of the first aspect and the possible implementations of the first aspect is performed.

According to a fifth aspect, a computer-readable storage medium is provided. The computer-readable storage medium stores computer instructions. When the computer instructions are run on a computer, the application display method according to any one of the first aspect and the possible implementations of the first aspect is performed.

According to a sixth aspect, a computer program product is provided. The computer program product includes computer program code. When the computer program code is run on a computer, the application display method according to any one of the first aspect and the possible implementations of the first aspect is performed.

### BRIEF DESCRIPTION OF THE DRAWINGS

FIG. 1 is a diagram of a structure of an electronic device according to an embodiment of this application;

FIG. 2 is a diagram of a software structure of an electronic device according to an embodiment of this application;

FIG. 3(a) to FIG. 3(c) are a diagram of a group of GUIs for switching a display interface according to an embodiment of this application;

FIG. 4 is a schematic flowchart of an application display method;

FIG. 5 is a schematic flowchart of an application display method according to an embodiment of this application;

FIG. 6 is a schematic flowchart of an application display method according to an embodiment of this application;

FIG. 7 is a diagram of a rotation animation tool module provided at an application framework layer according to an embodiment of this application; and

FIG. 8 is a schematic flowchart of an application display method according to an embodiment of this application.

### DETAILED DESCRIPTION OF ILLUSTRATIVE EMBODIMENTS

The following describes technical solutions of embodiments in this application with reference to accompanying drawings.

An application display method according to embodiments of this application may be applied to electronic devices such as a smartphone, a tablet computer, a notebook computer, a personal computer (PC), an ultra-mobile personal computer (UMPC), a netbook, a personal digital assistant (PDA), a vehicle-mounted device, a wearable device, or a foldable device.

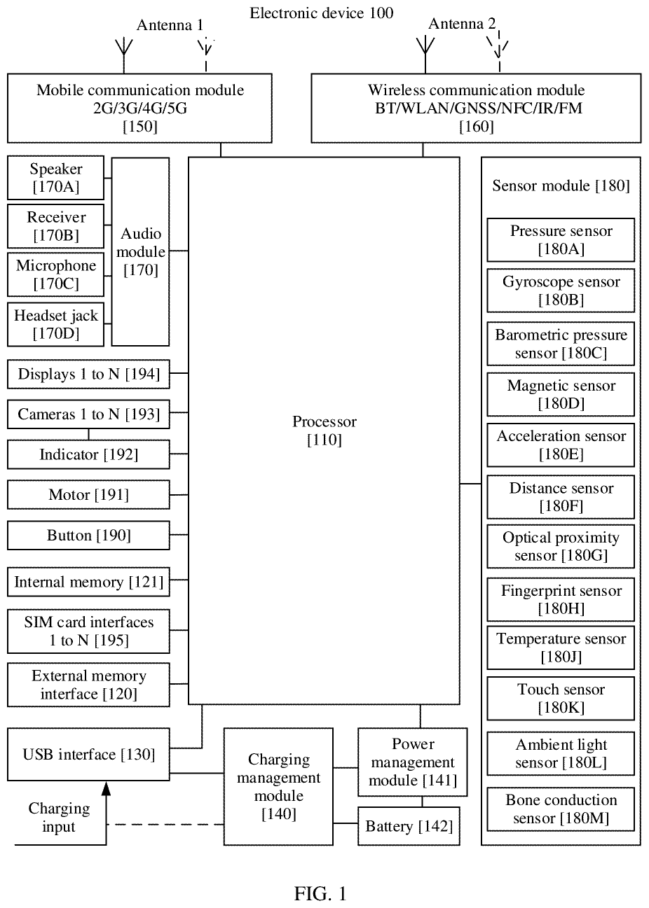

FIG. 1 is a diagram of a structure of an electronic device 100. The electronic device 100 may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (subscriber identity module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by using hardware, software, or a combination of software and hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors.

The controller may be a nerve center and a command center of the electronic device 100. The controller may generate an operation control signal based on instruction operation code and a time sequence signal, to complete control of instruction fetching and instruction execution.

A memory may be further disposed in the processor 110, and is configured to store instructions and data. In some embodiments, the memory in the processor 110 is a cache. The memory may store instructions or data just used or cyclically used by the processor 110. If the processor 110 needs to use the instructions or the data again, the processor 110 may directly invoke the instructions or the data from the memory. This avoids repeated access, reduces waiting time of the processor 110, and improves system efficiency.

In some embodiments, the processor 110 may include one or more interfaces. The interfaces may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus, and includes one serial data line (SDA) and one serial clock line (SCL).

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170.

The PCM interface may also be configured to: perform audio communication, and sample, quantize, and encode an analog signal. In some embodiments, the audio module 170 may be coupled to the wireless communication module 160 through a PCM bus interface.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 110 to the wireless communication module 160.

The MIPI interface may be configured to connect the processor 110 to a peripheral component like the display 194 or the camera 193.

The GPIO interface may be configured by software. The GPIO interface may be configured as a control signal or a data signal. In some embodiments, the GPIO interface may be configured to connect the processor 110 to the camera 193, the display 194, the wireless communication module 160, the audio module 170, the sensor module 180, or the like.

The USB interface 130 is an interface that conforms to a USB standard specification, and may be specifically a mini USB interface, a micro USB interface, a USB Type-C interface, or the like. The USB interface 130 may be configured to be connected to a charger to charge the electronic device 100, or may be configured to transmit data between the electronic device 100 and a peripheral device.

It may be understood that an interface connection relationship between the modules illustrated in embodiments of this application is merely an example for description, and does not constitute a limitation on the structure of the electronic device 100. In some other embodiments of this application, the electronic device 100 may alternatively use an interface connection manner different from that in the foregoing embodiment, or use a combination of a plurality of interface connection manners.

The charging management module 140 is configured to receive a charging input from a charger. The charger may be a wireless charger or a wired charger. In some embodiments of wired charging, the charging management module 140 may receive a charging input of a wired charger through the USB interface 130. In some embodiments of wireless charging, the charging management module 140 may receive a wireless charging input through a wireless charging coil of the electronic device 100. The charging management module 140 supplies power to the electronic device through the power management module 141 while charging the battery 142.

The power management module 141 is configured to connect to the battery 142, the charging management module 140, and the processor 110.

A wireless communication function of the electronic device 100 may be implemented through the antenna 1, the antenna 2, the mobile communication module 150, the wireless communication module 160, the modem processor, the baseband processor, and the like.

The mobile communication module 150 may provide a wireless communication solution that includes 2G/3G/4G/5G or the like and that is applied to the electronic device 100.

The modem processor may include a modulator and a demodulator. The modulator is configured to modulate a to-be-transmitted low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194. In some embodiments, the modem processor may be an independent component. In some other embodiments, the modem processor may be independent of the processor 110, and is disposed in a same device as the mobile communication module 150 or another function module.

The wireless communication module 160 may provide a wireless communication solution that includes a wireless local area network (wireless local area network, WLAN) (for example, a wireless fidelity (wireless fidelity, Wi-Fi) network), Bluetooth (Bluetooth, BT), Bluetooth low energy (Bluetooth low energy, BLE), a global navigation satellite system (global navigation satellite system, GNSS), frequency modulation (frequency modulation, FM), a near field communication (near field communication, NFC) technology, an infrared (infrared, IR) technology, or the like and that is applied to the electronic device 100.

In some embodiments, the antenna 1 and the mobile communication module 150 in the electronic device 100 are coupled, and the antenna 2 and the wireless communication module 160 in the electronic device 100 are coupled, so that the electronic device 100 can communicate with a network and another device by using a wireless communication technology.

The electronic device 100 may implement a display function through the GPU, the display 194, the application processor, and the like. The GPU is a microprocessor for image processing, and is connected to the display 194 and the application processor. The GPU is configured to perform mathematical and geometric computation, and render an image. The processor 110 may include one or more GPUs, which execute program instructions to generate or change display information.

The display 194 is configured to display an image, a video, and the like. The display 194 includes a display panel. The display panel may be a liquid crystal display (LCD), or may be a display panel made of one of materials such as an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device 100 may include one or N displays 194, where N is a positive integer greater than 1.

The electronic device 100 may implement a photographing function through the camera 193, the ISP, the video codec, the GPU, the display 194, the application processor and the like.

The ISP is configured to process data fed back by the camera 193. The camera 193 is configured to capture a static image or a video.

The digital signal processor is configured to process a digital signal, and may process another digital signal in addition to the digital image signal.

The video codec is configured to compress or decompress a digital video. The electronic device 100 may support one or more video codecs.

The external memory interface 120 may be used to connect to an external memory card, for example, a micro SD card, to extend a storage capability of the electronic device 100.

The internal memory 121 may be configured to store computer-executable program code. The executable program code includes instructions. The processor 110 runs the instructions stored in the internal memory 121, to perform various function applications of the electronic device 100 and data processing.

The electronic device 100 may implement an audio function, for example, music playing and recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal.

The speaker 170A, also referred to as a “loudspeaker”, is configured to convert an audio electrical signal into a sound signal.

The receiver 170B, also referred to as an “earpiece”, is configured to convert an electrical audio signal into a sound signal.

The microphone 170C, also referred to as a “mike” or a “mic”, is configured to convert a sound signal into an electrical signal.

The headset jack 170D is configured to connect to a wired headset.

The pressure sensor 180A is configured to sense a pressure signal, and can convert the pressure signal into an electrical signal. In some embodiments, the pressure sensor 180A may be disposed on the display 194.

The gyroscope sensor 180B may be configured to determine a moving posture of the electronic device 100.

The barometric pressure sensor 180C is configured to measure barometric pressure. In some embodiments, the electronic device 100 calculates an altitude through the barometric pressure measured by the barometric pressure sensor 180C, to assist in positioning and navigation.

The acceleration sensor 180E may detect accelerations in various directions (usually on three axes) of the electronic device 100.

The distance sensor 180F is configured to measure a distance.

The fingerprint sensor 180H is configured to collect a fingerprint.

The touch sensor 180K is also referred to as a touch panel. The touch sensor 180K may be disposed on the display 194, and a touchscreen, also referred to as a “touchscreen”, is formed by the touch sensor 180K and the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal.

The button 190 includes a power button, a volume button, and the like.

The motor 191 may generate a vibration prompt.

The indicator 192 may be an indicator light, and may be configured to indicate a charging status and a power change, or may be configured to indicate a message, a missed call, a notification, and the like.

The SIM card interface 195 is configured to connect to a SIM card.

A software system of the electronic device 100 may use a layered architecture, an event-driven architecture, a microkernel architecture, a micro service architecture, or a cloud architecture. In this embodiment of this application, an operating system with a layered architecture is used as an example to describe a software structure of the electronic device 100.

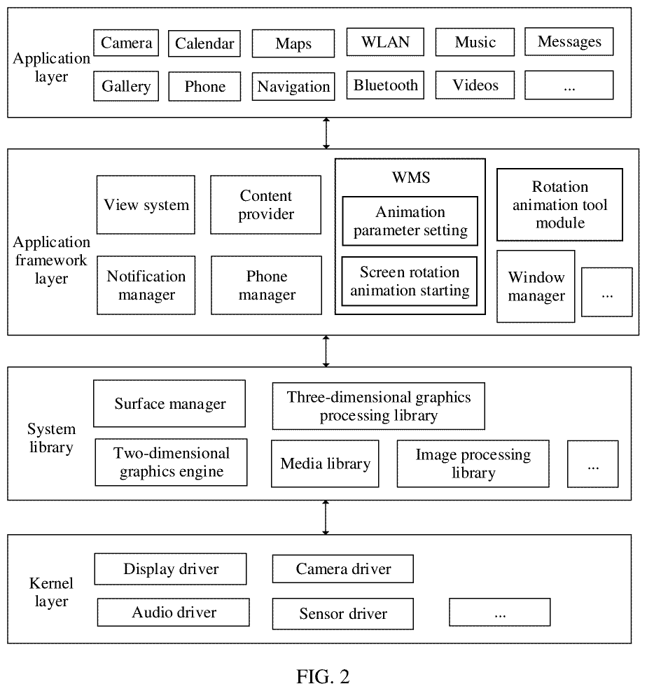

FIG. 2 is a block diagram of a software structure of the electronic device 100 according to an embodiment of this application. In a layered architecture, software is divided into several layers, and each layer has a clear role and task. The layers communicate with each other through a software interface. In some embodiments, an operating system is classified into four layers that are respectively an application layer, an application framework layer, a system library, and a kernel layer from top to bottom. The application layer may include a series of application packages.

As shown in FIG. 2, the application packages may include applications such as Camera, Gallery, Calendar, Phone, Maps, Navigation, WLAN, Bluetooth, Music, Videos, Messages, and Wallet.

The application framework layer provides an application programming interface (API) and a programming framework for an application at the application layer. The application framework layer includes some predefined functions.

As shown in FIG. 2, the application framework layer may include a window manager, a content provider, a view system, a phone manager, a resource manager, a notification manager, a window manager service (WMS), a rotation animation tool module, and the like.

The WMS may include a screen rotation animation starting interface and an animation parameter setting interface. The screen rotation animation starting interface may be configured to notify an application to start a screen rotation animation. The animation parameter setting interface may be configured to set a screen rotation animation parameter like a start angle and an end angle.

For example, the system may obtain a screen rotation animation parameter through the animation parameter setting interface, for example, an animation duration function may be used to determine duration of the screen rotation animation; or may obtain a start angle parameter and an end angle parameter of the screen rotation animation through the animation parameter setting interface, where the start angle parameter may be used to determine a start angle of the screen rotation animation, and the end angle parameter may be used to determine an end angle of the screen rotation animation.

It should be understood that a specific value of the animation duration function, the start angle parameter, and the end angle parameter may be set by a developer of an application, or may be generated by a system by default. This is not limited in embodiments of this application.

The rotation animation tool module may include a module for generating a screen rotation animation and a module for processing video stream splicing.

The window manager is configured to manage a window program. The window manager may obtain a size of the display, determine whether there is a status bar, perform screen locking, take a screenshot, and the like.

The content provider is configured to store and obtain data, and enable the data to be accessed by an application. The data may include a video, an image, audio, calls that are made and received, a browsing history, a bookmark, a phone book, and the like.

The view system includes visual controls such as a control for displaying a text and a control for displaying an image. The view system may be configured to construct an application. A display interface may include one or more views. For example, a display interface including a messages notification icon may include a text display view and an image display view.

The phone manager is configured to provide a communication function of the electronic device 100, for example, management of a call status (including answering, declining, or the like).

The resource manager provides various resources such as a localized character string, an icon, an image, a layout file, and a video file for an application.

The notification manager enables an application to display notification information in a status bar, and may be configured to convey a notification message. The notification manager may automatically disappear after a short pause without a user interaction. For example, the notification manager is configured to notify download completion, give a message notification, and the like. The notification manager may alternatively be a notification that appears in a top status bar of the system in a form of a graph or a scroll bar text, for example, a notification of an application that is run on a background, or may be a notification that appears on the screen in a form of a dialog window. For example, text information is displayed in the status bar, an alert sound is played, the electronic device vibrates, or the indicator light blinks.

A kernel library includes two parts: a function to be invoked by a Java language, and a kernel library.

The application layer and the application framework layer run on a virtual machine. The virtual machine executes java files of the application layer and the application framework layer as binary files. The virtual machine is configured to implement functions such as object lifecycle management, stack management, thread management, security and exception management, and garbage collection.

The system library may include a plurality of function modules, for example, a surface manager, a media library, a three-dimensional graphics processing library (for example, OpenGL ES), and a 2D graphics engine (for example, SGL).

The surface manager is configured to manage a display subsystem and provide fusion of 2D and 3D layers for a plurality of applications.

The media library supports playing and recording in a plurality of commonly used audio and video formats, and static image files. The media library may support a plurality of audio and video coding formats such as MPEG-4, H.264, MP3, AAC, AMR, JPG, and PNG.

The three-dimensional graphics processing library is configured to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

Before technical solutions of this application are described, some terms that may be used in embodiments of this application are first described.

Activity: a component that may include a user interface and is mainly used to interact with a user, for example, making a call, taking a photo, sending an email, and watching a video. Most content that can be viewed by the user in an application is provided by the activity component. An application may include a plurality of activities. In embodiments of this application, an interface corresponding to a first activity is a first display interface, and an interface corresponding to a second activity is a second display interface.

The following are two different service types:

Foreground: A foreground service can perform some operations that a user can notice. For example, an audio application uses the foreground service to play an audio track. The foreground service displays notifications. Even if the user stops interacting with the application, the foreground service continues to run.

Background: A background service performs operations that a user does not notice. For example, if an application uses a service to compress storage space of the application, the service is usually a background service.

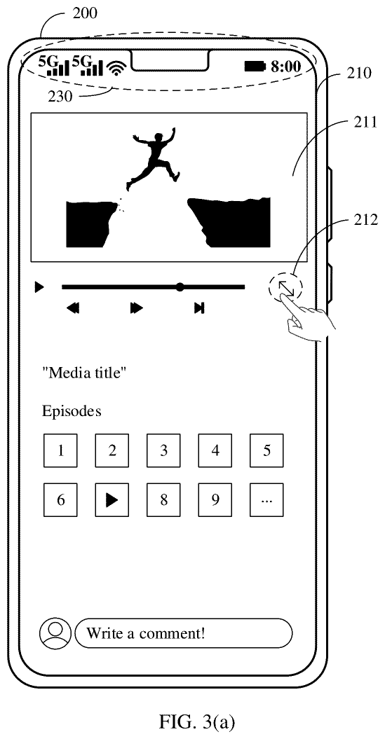

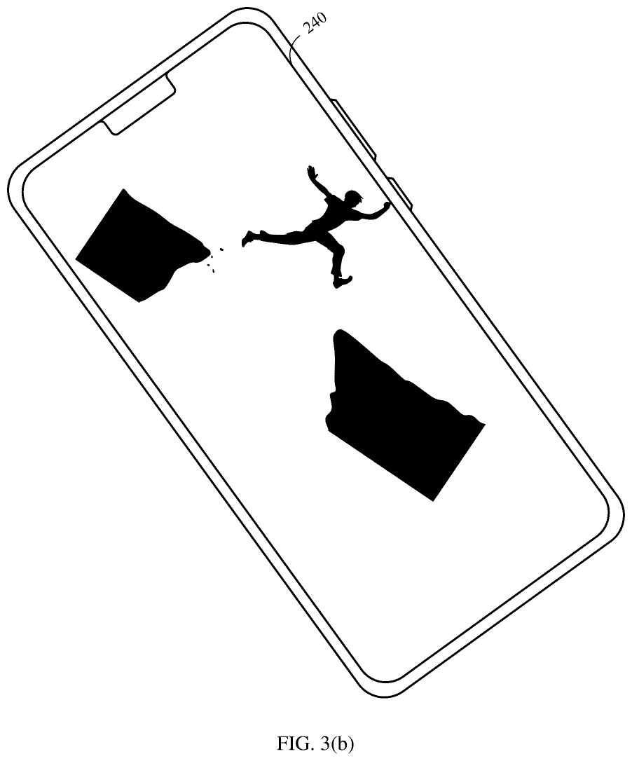

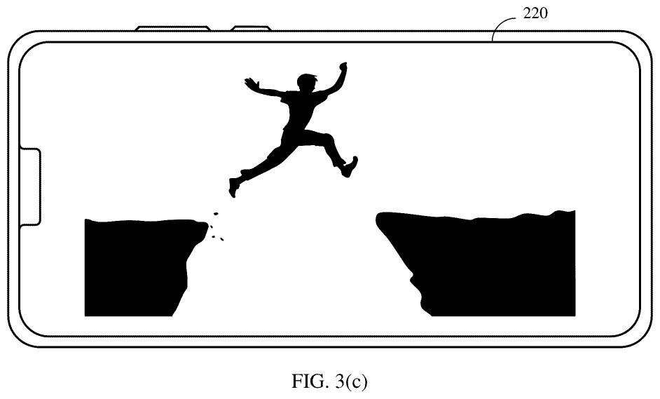

FIG. 3(a) to FIG. 3(c) are a diagram of a group of graphical user interfaces (graphical user interfaces, GUIs) according to an embodiment of this application. Herein, FIG. 3(a) to FIG. 3(c) are diagrams of switching a display direction of a mobile phone by a user.

As shown in FIG. 3(a), the GUI is a display interface 210 of a mobile phone 200. The display interface 210 may be a playing interface of Huawei Video, or the display interface 210 may be an interface of another application having a video playing function. This is not limited in this embodiment of this application. The display interface 210 may include a media playing area 211 and a status bar 230, and the display interface 210 may further include a media title, an episode, a comment input area, and the like. The status bar 230 may include a battery level, a time, a signal icon, a wireless connection icon, and the like. The media playing area 211 may include a media playing progress bar, a fast-forward button, a rewind button, and the like, and the media playing area 211 may further include a full-screen playing button 212.

It should be understood that the full-screen playing button 212 may alternatively be referred to as a switch button. This is not limited in this embodiment of this application.

After the mobile phone 200 detects an operation of tapping the full-screen playing button 212 by a user, and the user may further rotate a direction of the mobile phone 200, the mobile phone 200 performs display interface switching. In this case, the mobile phone 200 may display a GUI shown in FIG. 3(b).

As shown in FIG. 3(b), the GUI is a display interface 240 of the mobile phone 200, and the display interface 240 is a representation of the mobile phone 200 in a process of display interface switching. The display interface 240 may display media playing content. It should be understood that, on the display interface 240, the media playing content is in a switching process and is not completely displayed.

When the mobile phone 200 is rotated to a horizontal direction, the mobile phone 200 may display a GUI shown in FIG. 3(c).

As shown in FIG. 3(c), the GUI is a display interface 220 of the mobile phone 200. The display interface 220 displays the media playing content.

It should be understood that, after the user operation of tapping the full-screen playing button 212, the user may rotate the mobile phone 200 to the horizontal direction. In this case, the media playing content is displayed in a landscape orientation.

It should be understood that when the user taps the display interface 220, another status bar is displayed at the top of the display interface 220 of the mobile phone, and content included in the another status bar is the same as that included in the status bar 230. The another status bar is re-drawn by the system when the display interface is switched.

It should be understood that, in this embodiment of this application, a display direction of the mobile phone 200 may be a first display direction or a second display direction, and may be described as follows:

As shown in FIG. 3(a), when the display direction of the mobile phone is the first display direction, in an example, the display interface 210 of the mobile phone is vertically displayed on a display of the mobile phone, and a corresponding display interface may be referred to as a first display interface.

As shown in FIG. 3(c), when the display direction of the mobile phone is the second display direction, in an example, the display interface 220 of the mobile phone is horizontally displayed on the display of the mobile phone, and a corresponding display interface may be referred to as a second display interface.

In some other examples, after an auto-rotation button of the mobile phone is turned on, the user does not need to tap the full-screen playing button, and only needs to rotate the mobile phone to the horizontal direction, to display the media playing content horizontally.

It may be understood that FIG. 3(a) to FIG. 3(c) describes a process of switching the display direction of the mobile phone from a vertical direction to the horizontal direction. In some embodiments, a process of switching the mobile phone from the horizontal direction to the vertical direction may be an inverse process of the foregoing process. For example, the mobile phone 200 detects, in FIG. 3(c), an operation of tapping a switch button by the user, and the GUI shown in FIG. 3(b) may be displayed. After switching is completed, the mobile phone 200 may display the GUI shown in FIG. 3(a).

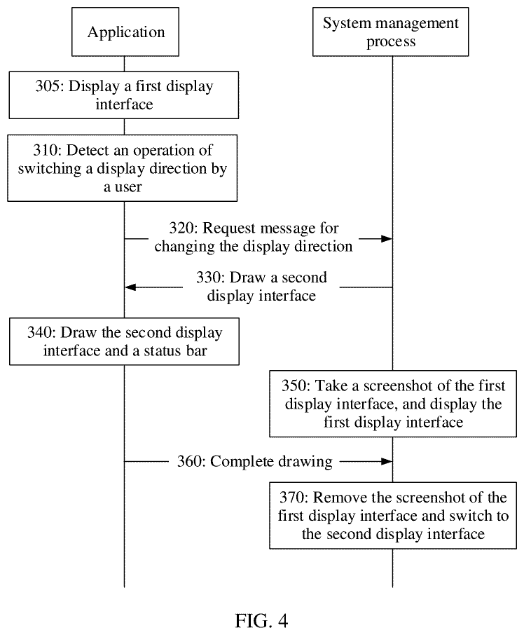

The foregoing describes, with reference to FIG. 3(a) to FIG. 3(c), a change of the display interface of the application when the mobile phone switches the display direction. The following describes, with reference to FIG. 4, an internal implementation process of a mobile phone when the mobile phone switches a display direction.

FIG. 4 is a schematic flowchart of an application display method. As shown in FIG. 4, the method may include the following steps.

305: Display a first display interface.

For example, as shown in FIG. 3(a), an application may be Huawei Video. When a user opens Huawei Video to watch a video, a mobile phone may display the video and related content in a portrait orientation. The first display interface may be a display interface 210 of the mobile phone in a first display direction.

310: Detect an operation of switching a display direction by the user.

As shown in FIG. 3(a), the operation of switching the display direction by the user may be an operation of tapping a full-screen playing button 212 on the display interface 210 by the user. Alternatively, the operation of switching the display direction by the user may be that the user rotates the mobile phone from the first display direction to a second display direction.

320: The application sends a request message for changing the display direction to a system management process. Correspondingly, the system management process receives the request message.

The request message may be used to request the system management process to change the display direction of a display of the mobile phone. For example, the request message may request to switch from vertical display to horizontal display, or the request message may request to switch from horizontal display to vertical display.

330: The system management process sends, to the application, a message for drawing a second display interface. Correspondingly, the application receives the message for drawing the second display interface that is sent by the system management process.

For example, the request message may be used to request to switch the mobile phone from the first display direction to the second display direction, and the second display interface may be a display interface of the mobile phone in the second display direction. In this case, the system management process may send, to the application, the message for drawing the second display interface.

340: The application draws the second display interface and a status bar.

When the display direction of the current display interface is switched, the application further needs to re-draw the status bar of the mobile phone when drawing the second display interface. The status bar may be a horizontal status bar.

350: The system management process takes a screenshot of the first display interface, and displays the screenshot of the first display interface.

The system management process takes a screenshot of the first display interface of the mobile phone, and displays the screenshot of the first display interface on the display of the mobile phone.

It should be understood that a screenshot may alternatively be referred to as a screen grab, and taking a screenshot of the mobile phone may be understood as obtaining a picture of the display interface of the mobile phone.

It should be understood that step 340 and step 350 may be performed synchronously, or step 340 and step 350 may be performed asynchronously.

360: The application sends, to the system management process, a message indicating that the second display interface and the status bar are drawn.

Correspondingly, the system management process may receive the message that is sent by the application and that indicates that the second display interface and the status bar are drawn.

It should be understood that, after the second display interface and the status bar are drawn, the application may send a drawing completion message to the system management process.

370: The system management process removes the screenshot of the first display interface and switches to the second display interface.

For example, the system management process removes the screenshot of the first display interface from the display, and moves the second display interface into the display. The screenshot of the first display interface presents a fade-out animation effect, and the second display interface presents a fade-in animation effect. In this way, the display direction of the display interface is switched.

In the foregoing process of switching the display direction of the display interface, in addition to re-drawing the second display interface, the application further needs to draw the status bar. As a result, a drawing process is slow, and a response delay is high, causing frame freezing. In addition, when the display direction is switched, the system needs to take a screenshot of the first display interface. As a result, video playing is temporarily interrupted, and continuity of video playing is affected.

In view of this, embodiments of this application provide an application display method and an electronic device. In this technical solution, when a display direction of a display interface is switched, different activities can be used to be responsible for display interfaces in different display directions. When the display direction is switched, a video stream is switched from one activity to another activity, avoiding frame freezing.

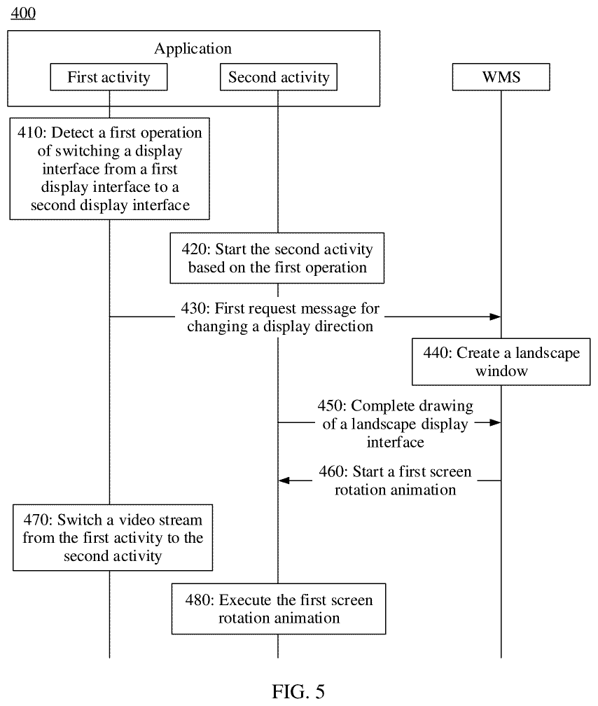

FIG. 5 is a schematic flowchart of an application display method according to an embodiment of this application. As shown in FIG. 5, the method 400 may include the following steps.

410: A first activity detects a first operation of switching a display interface from a first display interface to a second display interface.

For example, an application may be Huawei Video, and the first activity may be a playing interface of Huawei Video. As shown in FIG. 3(a) to FIG. 3(c), the first display interface may be a display interface 210, and the second display interface may be a display interface 220. The first operation may be an operation of tapping a full-screen display button 212 by a user, or the first operation may be an operation of rotating a mobile phone from a vertical direction to a horizontal direction by a user.

It should be understood that, that a display direction of the display interface is switched from vertical display to horizontal display may be understood as that the corresponding display interface is switched from the first display interface to the second display interface.

420: The application starts a second activity based on the first operation.

For example, the application may start the second activity after detecting the first operation of switching the display interface from the first display interface to the second display interface. A display interface corresponding to the second activity is the second display interface.

It should be understood that the second activity is created by the application by invoking a system interface, the display interface corresponding to the second activity is the second display interface, and a display interface corresponding to the first activity is the first display interface. Different activities are responsible for display interfaces in different display directions, so that a switching process can be smooth and natural without frame freezing.

430: The application sends a first request message for changing the display direction to a window manager service WMS. Correspondingly, the WMS receives the first request message.

It should be understood that the first request message is used to request to switch the display direction from a first display direction to a second display direction. Alternatively, the first request message may be further understood as being used to request to switch the display interface from the first display interface to the second display interface.

440: The WMS creates a landscape window.

It should be understood that the landscape window may be used to carry the second display interface, or may be understood as that the landscape window is used to carry the display interface corresponding to the second activity.

450: The application sends, to the WMS, a message indicating that the second display interface is drawn. Correspondingly, the WMS receives the message indicating that the second display interface is drawn.

460: The WMS sends, to the second activity, a message for starting a first screen rotation animation. Correspondingly, the application receives the message for starting the first screen rotation animation.

It should be understood that the first screen rotation animation may be an animation for switching the display interface of the electronic device from the first display interface to the second display interface. For example, the first display interface exits, and the second display interface enters.

For example, the WMS may include a video animation starting (apply Video Animation) interface, and the WMS may send, to the application through the video animation starting interface, the message for starting the first screen rotation animation.

470: The application switches a video stream from the first activity to the second activity.

In some examples, an application framework layer provides, for the application, an interface for video stream switching. The application may switch the video stream from a portrait activity to a landscape activity by invoking the interface for video stream switching.

For example, when the mobile phone displays the first display interface, the application displays, in the first activity, the video stream in a video stream buffer queue (buffer queue). When the user triggers an operation of switching the display direction, the application may switch the video stream in the video stream buffer queue from the first activity to the second activity through the interface for video stream switching, to ensure uninterrupted video playing in the switching process.

480: The application executes the first screen rotation animation.

For example, the first screen rotation animation may be used to remove the first display interface, and move the second display interface in. Because the video stream is switched to the second activity before the screen rotation animation is executed, in the process of switching the display direction, video playing may be kept uninterrupted, and the process of display interface switching is smooth and natural.

For example, the application framework layer may provide, for the application, a system interface for generating the first screen rotation animation. The application may invoke the system interface to generate the first screen rotation animation, and execute the first screen rotation animation, to switch the display interface from the first display interface to the second display interface.

In this embodiment of this application, the application may execute the first screen rotation animation based on an animation parameter. The animation parameter may be animation duration, an animation start angle, an animation end angle, or the like of the first screen rotation animation. A specific value of the animation parameter may be freely set by a developer of the application. When display interface switching of the application is triggered, the application may obtain the first screen rotation animation through the system interface for generating the first screen rotation animation, and execute the obtained first screen rotation animation based on the animation parameter.

Alternatively, the application framework layer may further include an interface for setting the animation parameter of the first screen rotation animation. When display interface switching of the application is triggered, the application may obtain the first screen rotation animation through the system interface for generating the first screen rotation animation, obtain the animation parameter through the interface for setting the animation parameter of the first screen rotation animation, and execute the obtained first screen rotation animation based on the animation parameter.

It should be understood that, in step 480, after the second activity executes the first screen rotation animation, the second activity is in a foreground of the electronic device, and may directly receive an operation of the user. The first activity is in a background of the electronic device, and is in a suspended state.

In some embodiments, the first activity may alternatively be directly destroyed. Alternatively, if the first activity is in the background of the electronic device for a period of time and is not switched to the foreground, the first activity may be destroyed.

It should be understood that an execution sequence of step 410 to step 480 is not limited in this application. In some embodiments, some steps in step 410 to step 480 may not be performed, or may be replaced with other steps.

In an example, the technical solution in this application is applied to the mobile phone. When a video played on the mobile phone is switched from the first display direction to the second display direction, compared with that in a conventional switching manner, a response delay is reduced from 467 ms to 155 ms. Therefore, a response speed of switching the display direction is improved, and the switching process is smooth and natural.

In an embodiment of this application, after the user triggers the operation of switching the display interface from the first display interface to the second display interface, the application may start the second activity. The WMS may create the landscape window for the second activity, and the application draws a landscape second display interface. After the second display interface is drawn, the WMS may send, to the application, a message for starting the screen rotation animation. Then, the application switches the video stream from the first activity to the second activity, and executes the screen rotation animation. In this technical solution, when the display interface of the electronic device is switched from the first display interface to the second display interface, the electronic device may start the second activity to be responsible for displaying the second display interface. Switching may be performed after the second display interface is drawn, without waiting for a horizontal status bar to be drawn, so that a response speed of a switching operation can be improved. In addition, before switching is performed, the video stream is switched from the first activity to the second activity, so that video playing can be kept uninterrupted without frame freezing in the process of switching the display direction.

The foregoing describes, with reference to steps 410 to 480, the technical solution for switching the display interface from the first display interface to the second display interface. In some cases, the method 400 may further include switching back from the second display interface to the first display interface.

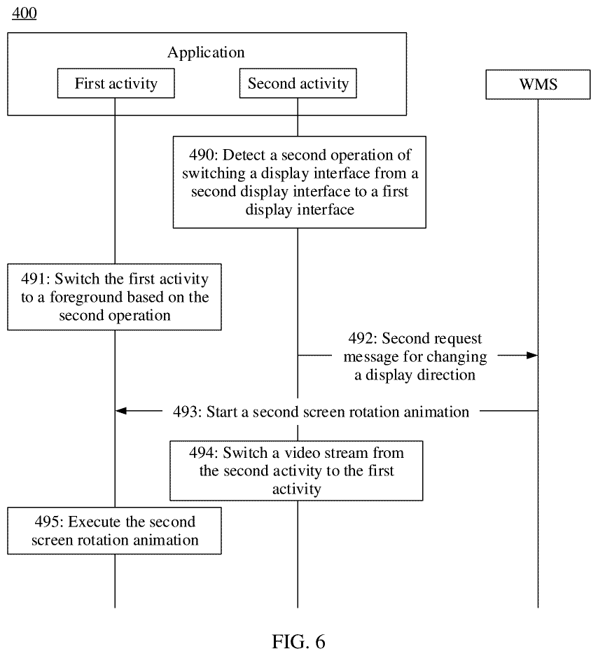

In some other embodiments, refer to FIG. 6. FIG. 6 is a schematic flowchart of another application display method according to an embodiment of this application. The application display method 400 may further include the following steps.

490: Detect a second operation of switching the display interface from the second display interface to the first display interface.

For example, the second operation may be an operation of tapping a switch button by the user. Alternatively, the second operation may be an operation of rotating, by the user, the electronic device from the second display direction to the first display manner.

491: The application switches the first activity to the foreground based on the second operation.

It should be understood that, because the first activity is in the background, the application may switch the first activity from the background to the foreground based on the second operation, and the first display interface corresponding to the first activity does not need to be re-drawn. In this case, the application displays the first display interface corresponding to the first activity.

492: The second activity sends, to the WMS, a second request message for changing the display direction. Correspondingly, the WMS receives the second request message.

It should be understood that the second request message may be used to request to switch the display direction from the first display direction to the second display direction. Alternatively, the second request message may be understood as being used to request to switch the display interface from the second display interface to the first display interface.

493: The WMS sends, to the first activity, a message for starting a second screen rotation animation. Correspondingly, the application receives the message for starting the second screen rotation animation.

It should be understood that the second screen rotation animation may be an animation for switching the display interface from the second display interface to the first display interface. For example, the second display interface exits, and the first display interface enters.

For example, the WMS may include the video animation starting (apply Video Animation) interface, and the WMS may send, to the first activity through the video animation starting interface, the message for starting the second screen rotation animation.

494: The application switches the video stream from the second activity to the first activity.

In some examples, the application framework layer provides, for the application, the interface for video stream switching. The application may switch the video stream from the second activity to the first activity by invoking the interface for video stream switching.

For example, when the mobile phone displays the second display interface, the application displays, in the second activity, the video stream in the video stream buffer queue (buffer queue). When the user triggers switching of the display direction, the application may switch the video stream in the video stream buffer queue from the second activity to the first activity through the interface for video stream switching.

495: The first activity executes the second screen rotation animation.

For example, the second screen rotation animation may be used to remove the second display interface, and move the first display interface in. Because the video stream is switched to the first activity before the screen rotation animation is executed, in the process of switching the display direction, video playing may be kept uninterrupted, and the switching process is smooth and natural.

For example, the application framework layer may provide, for the application, a system interface for generating the second screen rotation animation, so that the application may invoke the system interface to generate the second screen rotation animation, and execute the second screen rotation animation, to switch the display interface from landscape display to portrait display.

It should be understood that, in this embodiment of this application, when the display interface is switched back to the first display interface, the second activity may be destroyed, so that occupation of running memory of the electronic device can be reduced.

In some other examples, the second activity may alternatively be switched to the background and suspended. Alternatively, if the second activity is switched to the background and is not switched back to the foreground within a period of time, the second activity may be destroyed.

It should be understood that steps 490 to 495 may be performed after or before step 480, or may be separately performed. This is not limited in embodiments of this application.

It should be understood that an execution sequence of step 490 to step 495 is not limited in this application. In some embodiments, some steps in step 490 to step 495 may not be performed, or may be replaced with other steps.

It may be understood that, in the technical solution corresponding to FIG. 4, after the user triggers the operation of switching from the first display interface to the second display interface, because the second display interface and the first display interface share one activity, the application needs to re-draw the first display interface. During the switching, the system needs to take a screenshot of the second display interface, and this also causes video playing interruption.

In an embodiment of this application, after the user triggers the operation of switching the display interface from the second display interface to the first display interface, the application may switch the first activity back to the foreground. The WMS may send, to the application, a message for starting a screen rotation animation, and then the application switches the video stream from the second activity to the first activity, and executes the screen rotation animation. In this technical solution, when the display interface of the electronic device is switched back from the second display interface to the first display interface, the electronic device only needs to switch the first activity back to the foreground to perform switching, and does not need to re-draw the first display interface, so that a response speed of a switching operation can be improved. In addition, before the switching is performed, the video stream is switched from the second activity to the first activity, so that video playing can be kept uninterrupted in the process of switching the display direction, so as to ensure continuity of video playing.

The foregoing describes, with reference to FIG. 5 and FIG. 6, a process in which the display direction of the display interface of the electronic device is switched from the first display direction to the second display direction and then switched back to the first display direction. In some other embodiments, the display direction of the electronic device may alternatively be switched from the second display direction to the first display direction and then switched back to the second display direction. For a specific process, refer to the foregoing related descriptions. For brevity, details are not described again. For example, when the electronic device is a tablet, when a user normally uses the tablet, a display direction of a display interface of the tablet is horizontal display. When the user switches the display direction from horizontal display to vertical display, refer to the foregoing specific descriptions.

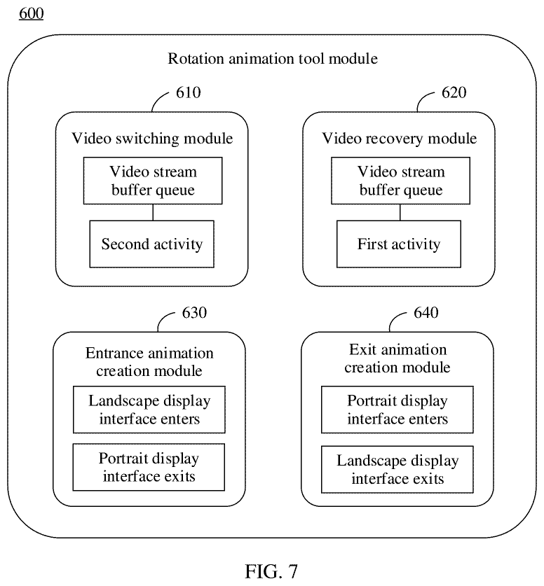

FIG. 7 is a diagram of a rotation animation tool module provided at an application framework layer according to an embodiment of this application.

As shown in FIG. 7, the rotation animation tool (Rotate Animation Utils) module 600 may include several function modules such as a video switching (make Video Transition) module 610, a video recovery (make Video Recover) module 620, an entrance animation creation (create Enter Animation) module 630, and an exit animation creation (create Exit Animation) module 640.

It should be understood that a system provides, for an application, a rotation animation generation (make Rotation Animation) interface, and the application may invoke a corresponding function module in the rotation animation tool module 600 through the rotation animation generation interface.

In some examples, the video switching module 610 may be configured to switch a video stream from a first activity to a second activity. For example, refer to step 470 in the foregoing description. If a display interface of an electronic device is a first display interface, the video stream is displayed in the first activity. When a user triggers an operation of switching the display interface from the first display interface to a second display interface, the electronic device may invoke, through the system interface, the video switching module 610 to switch the video stream from the first activity to the second activity.

In some examples, the video recovery module 620 may be configured to switch the video stream from the second activity to the first activity. For example, refer to step 494 in the foregoing description. If the display interface of the electronic device is the second display interface, the video stream is displayed in the second activity. When the user triggers an operation of switching the display interface from the second display interface to the first display interface, the electronic device may invoke, through the system interface, the video recovery module 620 to switch the video stream from the second activity to the first activity.

In some examples, the entrance animation creation module 630 may be configured to generate an entrance animation of the second display interface and an exit animation of the first display interface. For example, refer to step 480 in the foregoing description. If the user triggers the display interface to switch from the first display interface to the second display interface, the electronic device may invoke, through the system interface, the entrance animation creation module 630 to perform a screen rotation animation, remove the first display interface, and move the second display interface in.

In some examples, the exit animation creation module 640 may be configured to generate an entrance animation of the first display interface and an exit animation of the second display interface. For example, refer to step 495 in the foregoing description. If the user triggers the display interface to switch from the second display interface to the first display interface, the electronic device may invoke, through the system interface, the exit animation creation module 640 to perform a screen rotation animation, remove the second display interface, and move the first display interface in.

In an embodiment of this application, the system interface for generating the rotation animation is set for the application. When the user triggers switching of the display interface, the application may invoke a corresponding function module through the system interface, to implement switching of the video stream, generation of the screen rotation animation, and the like, so as to help improve an application scope of the technical solution.

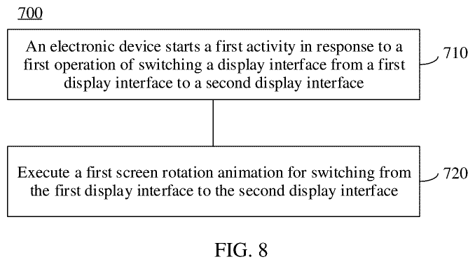

FIG. 8 is a schematic flowchart of an application display method according to an embodiment of this application. The method 700 may be applied to an electronic device, and the method 700 may include step 710 and step 720.

710: An electronic device starts a second activity in response to a first operation of switching a display interface from a first display interface to a second display interface, where a display interface corresponding to the second activity is the second display interface, an activity corresponding to the first display interface is a first activity, and display directions of the first display interface and the second display interface on a display of the electronic device are different.

For example, the first display interface may be a display interface corresponding to the first display direction described above, and the second display interface may be a display interface corresponding to the second display direction described above.

As shown in FIG. 3(a) to FIG. 3(c), the first display interface may be the vertical display interface 210, and the second display interface may be the horizontal display interface 220. It should be understood that the first operation of switching the display interface from the first display interface to the second display interface may alternatively be understood as an operation of switching a display direction of the display interface from the first display direction to the second display direction.

In some other examples, the first display interface may alternatively be a display interface corresponding to the second display direction described above, and the second display interface may be a display interface corresponding to the first display direction described above. This is not limited in this embodiment of this application.

A currently displayed display interface of the electronic device is the first display interface, and an activity corresponding to the first display interface is the first activity. When detecting the first operation, the electronic device may start the second activity, where the display interface corresponding to the second activity is the second display interface, and execute a first screen rotation animation for switching from the first display interface to the second display interface. In this embodiment of this application, display interfaces in different display directions correspond to different activities, but do not share a same activity.

720: The electronic device executes the first screen rotation animation for switching from the first display interface to the second display interface.

For example, the electronic device may switch the display interface from the first display interface to the second display interface, and the first screen rotation animation may be an exit animation of the first display interface and an entrance animation of the second display interface.

In this embodiment of this application, the electronic device starts the second activity after detecting the operation of switching the display direction. The second activity corresponds to the second display interface in the second display direction. Then, the electronic device executes the first screen rotation animation for switching from the first display interface to the second display interface. According to the technical solution, different activities are used to be responsible for display interfaces in different display directions, and screenshot processing does not need to be performed on the display interface, avoiding frame freezing that occurs when the display direction is switched.

In some embodiments, before step 720, the method 700 may further include:

The electronic device creates a window used to carry the second display interface, and draws the second display interface.

For example, a WMS of the electronic device may create the window to carry the second display interface. The second display interface may be drawn by an application in the electronic device. After the second display interface is drawn, step 720 is performed.

In some embodiments, the first display interface is a display interface of a video played by the electronic device. Before the electronic device executes the first screen rotation animation for switching from the first display interface to the second display interface, the method 700 may further include:

The electronic device switches a video stream of the video from the first activity to the second activity.

For example, the first display interface may be a video playing interface of Huawei Video. In this case, a video stream of a video that is being played is displayed in the first activity. When detecting the operation of switching the display direction by a user, the electronic device may switch the video stream from the first activity to the second activity, to ensure uninterrupted video playing.

In some other embodiments, the first display interface may be another display interface other than a video playing interface, for example, a text display interface. This is not limited in this application.

In some embodiments, the method 700 may further include:

The electronic device draws a third display interface, where the third display interface is a display interface of a status bar of the electronic device.

It should be understood that the electronic device may draw the third display interface after performing a switching action. The third display interface is a display interface of the status bar of the electronic device in a direction corresponding to the second display interface.

For example, if the second display interface is a horizontal display interface, the third display interface is a horizontal display interface of the status bar.

In this embodiment of this application, the electronic device may perform the switching action after drawing the second display interface, without waiting for the status bar to be drawn. The status bar may be drawn after the display direction is switched, so that switching between display interfaces is smoother when the display direction is switched, avoiding frame freezing.

In some embodiments, that the electronic device executes the first screen rotation animation for switching from the first display interface to the second display interface includes:

The electronic device obtains animation duration, a start angle, and an end angle of the first screen rotation animation; and
the electronic device executes the first screen rotation animation based on the animation duration, the start angle, and the end angle of the first screen rotation animation.

It should be understood that the first screen rotation animation may be the entrance animation of the second display interface and the exit animation of the first display interface.

For example, as shown in FIG. 7, the system provides the system interface for the application, and the application may invoke, through the system interface, the entrance animation creation module 630 in the rotation animation tool module to obtain the first screen rotation animation.

In this embodiment of this application, a framework layer of the electronic device may provide a system interface, and the electronic device may obtain an animation through the system interface and execute the animation based on an animation parameter. In this technical solution, when different applications in the electronic device switch display directions, animations may be obtained through the system interface. This helps improve applicability of the animation for switching the display direction.

In some embodiments, the first operation includes at least one of the following operations: an operation of tapping a display direction switching icon on the first display interface; or an operation of rotating the electronic device by a first preset angle.

For example, the display direction switching icon may be a maximize button, a rotation button, or the like on the first display interface.

For example, the operation of rotating the electronic device by the first preset angle may be that the user rotates the electronic device from a vertical direction to a horizontal direction, or from a horizontal direction to a vertical direction. The first preset angle may be 90degrees, 85 degrees, or the like. A specific value of the first preset angle is not limited in this embodiment of this application.

In some embodiments, the first activity is switched to a background when the display interface of the electronic device is switched from the first display interface to the second display interface.

In this embodiment of this application, when the electronic device is switched from the first display interface to the second display interface, the first activity corresponding to the first display interface is switched to the background. In this case, the second activity corresponding to the second display interface is in a foreground. In this technical solution, when the electronic device switches from the second display interface back to the first display interface, the first activity only needs to be switched to the foreground, and the first display interface does not need to be re-drawn, so that switching smoothness can be improved.

In some embodiments, the method 700 may further include:

The electronic device detects a second operation of the user, where the second operation is used to switch the display interface of the electronic device from the second display interface to the first display interface;
the electronic device switches the first activity from the background to the foreground in response to the second operation; and
the electronic device executes a second screen rotation animation for switching from the second display interface to the first display interface.

In some cases, the electronic device switches back from the second display interface to the first display interface. For example, after detecting, on the second display interface, an operation of tapping a switch icon by the user, the electronic device switches the first activity from the background to the foreground. In this case, the display interface of the electronic device may be switched from the second display interface to the first display interface.

In this embodiment of this application, after detecting the operation of switching from the second display interface back to the first display interface, the electronic device may switch the first activity back to the foreground, and execute the switching animation. In this technical solution, the first display interface does not need to be re-drawn, so that switching smoothness can be improved.

In some embodiments, the second display interface is a display interface of the video played by the electronic device. Before the electronic device executes the second screen rotation animation for switching from the second display interface to the first display interface, the method 700 may further include:

The electronic device switches the video stream of the video from the second activity to the first activity.

When the electronic device displays the second display interface, the video stream is displayed in the second activity corresponding to the second display interface. When the second operation is detected, the electronic device may switch the video stream from the second activity back to the first activity.

In this embodiment of this application, when the electronic device plays the video, and when the display direction is switched, the electronic device switches the video stream from the second activity to the first activity, so as to ensure uninterrupted video playing.

In some embodiments, that the electronic device executes the second screen rotation animation for switching from the second display interface to the first display interface includes:

The electronic device obtains animation duration, a start angle, and an end angle of the second screen rotation animation; and
the electronic device executes the second screen rotation animation based on the animation duration, the start angle, and the end angle of the second screen rotation animation.

It should be understood that the second screen rotation animation may be an exit animation of the second display interface and an entrance animation of the first display interface.

For example, as shown in FIG. 7, the system provides the system interface for the application, and the application may invoke, through the system interface, the exit animation creation module 640 in the rotation animation tool module to obtain the second screen rotation animation.

In this embodiment of this application, a framework layer of the electronic device may provide a system interface, and the electronic device may obtain an animation through the system interface and execute the animation based on an animation parameter. In this technical solution, when different applications in the electronic device switch display directions, animations may be obtained through the system interface, and the animation is executed based on the animation parameter. This helps improve applicability of the animation for switching the display direction.

In some embodiments, the second operation includes at least one of the following operations:
an operation of tapping a display direction switching icon on the second display interface; or an operation of rotating the electronic device by a second preset angle.

For example, the display direction switching icon may be a rotation button, a direction switching button, or the like on the second display interface.

For example, the operation of rotating the electronic device by the second preset angle may be that the user rotates the electronic device from a horizontal direction to a vertical direction, or from a vertical direction to a horizontal direction. The second preset angle may be 90 degrees, 85 degrees, or the like. A specific value of the second preset angle is not limited in this embodiment of this application.

An embodiment of this application further provides an electronic device, including one or more processors and one or more memories. The one or more memories store one or more computer programs. The one or more computer programs include instructions. When the instructions are executed by the one or more processors, the application display method according to the foregoing embodiments is performed.

An embodiment of this application further provides an application display apparatus, including a module configured to implement the application display method according to the foregoing embodiments.

An embodiment of this application further provides a chip. The chip includes a processor and a communication interface. The communication interface is configured to receive a signal and transmit the signal to the processor. The processor processes the signal, so that the application display method according to the foregoing embodiments is performed.

An embodiment of this application further provides a computer-readable storage medium. The computer-readable storage medium stores computer instructions. When the computer instructions are run on a computer, the application display method according to the foregoing embodiments is performed.

An embodiment of this application further provides a computer program product. The computer program product includes computer program code. When the computer program code is run on a computer, the application display method according to the foregoing embodiments is performed.

A person of ordinary skill in the art may be aware that, in combination with units and algorithm steps of the examples described in embodiments disclosed in this specification, this application can be implemented by electronic hardware or a combination of computer software and electronic hardware. Whether the functions are performed by hardware or software depends on particular applications and design constraints of the technical solution. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate components may or may not be physically separate, and parts displayed as units may or may not be physical units, may be located in one place, or may be distributed on a plurality of network units. Some or all of the units may be selected based on actual requirements to achieve the objectives of the solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or a compact disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method comprising:
starting, by an electronic device, a second activity in response to a first operation of switching a display interface from a first display interface that corresponds to a first activity to a second display interface that corresponds to the second activity, and display directions of the first display interface and the second display interface on a display of the electronic device are different; and
executing, by the electronic device, a first screen rotation animation for switching from the first display interface to the second display interface.

2. The method according to claim 1, wherein the first display interface is a display interface of a video, and before executing, by the electronic device, the first screen rotation animation for switching from the first display interface to the second display interface, the method further comprises:
switching, by the electronic device, a video stream of the video from the first activity to the second activity.

3. The method according to claim 1, wherein the method further comprises:
drawing, by the electronic device, a third display interface, wherein the third display interface is a display interface of a status bar of the electronic device.

4. The method according to claim 1, wherein executing, by the electronic device, the first screen rotation animation for switching from the first display interface to the second display interface comprises:
obtaining, by the electronic device, an animation duration, a start angle, and an end angle of the first screen rotation animation; and
executing, by the electronic device, the first screen rotation animation based on the animation duration, the start angle, and the end angle of the first screen rotation animation.

5. The method according to claim 1, wherein the first operation comprises:
an operation of tapping a display direction switching icon on the first display interface; or
an operation of rotating the electronic device by a first preset angle.

6. The method according to claim 1, wherein the first activity is switched to a background of the electronic device when the display interface of the electronic device is switched from the first display interface to the second display interface.

7. The method according to claim 6, wherein the method further comprises:
detecting, by the electronic device, a second operation of a user, wherein the second operation indicates to switch the display interface of the electronic device from the second display interface to the first display interface;
switching, by the electronic device, the first activity from the background to a foreground of the electronic device in response to the second operation; and
executing, by the electronic device, a second screen rotation animation for switching from the second display interface to the first display interface.

8. The method according to claim 7, wherein the second display interface is a display interface of a video played by the electronic device, and before executing, by the electronic device, the second screen rotation animation for switching from the second display interface to the first display interface, the method further comprises:
switching, by the electronic device, a video stream of the video from the second activity to the first activity.

9. The method according to claim 7, wherein executing, by the electronic device, the second screen rotation animation for switching from the second display interface to the first display interface comprises:
obtaining, by the electronic device, an animation duration, a start angle, and an end angle of the second screen rotation animation; and
executing, by the electronic device, the second screen rotation animation based on the animation duration, the start angle, and the end angle of the second screen rotation animation.

10. The method according to claim 7, wherein the second operation comprises:
an operation of tapping a display direction switching icon on the second display interface; or
an operation of rotating the electronic device by a second preset angle.

11. An electronic device, comprising:
one or more processors; and
one or more memories, wherein the one or more memories store one or more computer programs, the one or more computer programs comprise instructions, and when the instructions are executed by the one or more processors, the electronic device is enabled to:
start a second activity in response to a first operation of switching a display interface from a first display interface that corresponds to a first activity to a second display interface that corresponds to the second activity, wherein display directions of the first display interface and the second display interface on a display of the electronic device are different; and
execute a first screen rotation animation for switching from the first display interface to the second display interface.

12. The electronic device according to claim 11, wherein the first display interface is a display interface of a video, and when the instructions are executed by the one or more processors, the electronic device is enabled to:
switch a video stream of the video from the first activity to the second activity.

13. The electronic device according to claim 11, wherein when the instructions are executed by the one or more processors, the electronic device is enabled to:
draw a third display interface, wherein the third display interface is a display interface of a status bar of the electronic device.

14. The electronic device according to claim 11, wherein when the instructions are executed by the one or more processors, the electronic device is enabled to:
obtain animation duration, a start angle, and an end angle of the first screen rotation animation; and
execute the first screen rotation animation based on the animation duration, the start angle, and the end angle of the first screen rotation animation.

15. The electronic device according to claim 11, wherein the first operation comprises:
an operation of tapping a display direction switching icon on the first display interface; or
an operation of rotating the electronic device by a first preset angle.

16. The electronic device according to claim 11, wherein the first activity is switched to a background of the electronic device when the display interface of the electronic device is switched from the first display interface to the second display interface.

17. The electronic device according to claim 16, wherein when the instructions are executed by the one or more processors, the electronic device is enabled to:
detect a second operation of a user, wherein the second operation indicates to switch the display interface of the electronic device from the second display interface to the first display interface;
switch the first activity from the background to a foreground of the electronic device in response to the second operation, wherein the second operation comprises an operation of tapping a display direction switching icon on the second display interface or an operation of rotating the electronic device by a second preset angle; and
execute a second screen rotation animation for switching from the second display interface to the first display interface.

18. The electronic device according to claim 17, wherein the second display interface is a display interface of a video played by the electronic device, and when the instructions are executed by the one or more processors, the electronic device is enabled to:
switch a video stream of the video from the second activity to the first activity.

19. The electronic device according to claim 17, wherein when the instructions are executed by the one or more processors, the electronic device is enabled to:
obtain an animation duration, a start angle, and an end angle of the second screen rotation animation; and
execute the second screen rotation animation based on the animation duration, the start angle, and the end angle of the second screen rotation animation.

20. A non-transitory computer-readable storage medium of an electronic device, wherein the non-transitory computer-readable storage medium stores computer instructions, and when the computer instructions are run on a computer, the computer is enabled to:
start a second activity in response to a first operation of switching a display interface from a first display interface that corresponds to a first activity to a second display interface that corresponds to a second activity, wherein display directions of the first display interface and the second display interface on a display of the electronic device are different; and
execute a first screen rotation animation for switching from the first display interface to the second display interface.
